(19) United States
(12) Patent Application Publication
(10) Pub. No.: US 2009/0064835 A1
(43) Pub. Date: Mar. 12, 2009

(54) Blind cutting machine having a work piece positioning mechanism

(76) Inventor: Chaohung Nien, (US)

Correspondence Address: BUCHANAN INGERSOLL & ROONEY PC, P.O. BOX 1404, ALEXANDRIA, VA, 22313-1404, US

(21) Appl. No.: 12/148,831

(22) Filed: Apr. 23, 2008

(30) Foreign Application Priority Data
Sep. 10, 2007 (CN) 200720128669.4

(51) Int. Cl. B26D 7/02; B26D 7/01; B23Q 7/04

(52) U.S. Cl. 83/466; 83/468.7; 29/559

(57) ABSTRACT

A cutting machine for trimming window coverings and window covering components is disclosed that includes a stand, a cutting mechanism adjacent the stand and a work piece positioning mechanism which enables the cutting machine trim valance components. The cutting mechanism has one or more blades configured to move along a cutting path to cut a work piece. The work piece positioning mechanism is moveable from a first position to a second position and is sized and configured to hold at least one valance component or other work piece at an acute angle relative to the cutting path when the work piece positioning mechanism is in the second position.

### FIELD OF INVENTION

The present invention relates to window covering cutting machines.

### BACKGROUND OF THE INVENTION

Stock blinds have grown in demand over the past few years in the window covering industry. Stock sized window treatments are typically mass produced by a manufacturer and sold at relatively low cost through home centers and other retail stores. A manufacturer will make stock blinds in three or four stock sizes that can be cut down in the store to fit most rectangular window openings. Such stock blinds are desirable to many customers because the stock sized window coverings are typically offered at lower costs than custom made window coverings.

Customers may select a stock blind or other stock shade that is relatively near, but larger than, the dimensions of a particular window opening to be covered and have the blind cut down to fit within the window opening. Retailers often have cutting machines configured to cut down the window covering products they may sell to customers so the product can be cut down at the time the consumer purchases the stock window covering. Window covering cutting machines typically include a cutting device, such as a blade or die, and a stand. The cutting device is typically adjacent the stand. Usually, a work surface that may support a portion of a blind about to be cut down by the cutting machine is positioned adjacent the cutting device. The cutting machines also often include a clamp that is configured to hold a window covering work piece, such as a blind, shade, headrail, window covering material or bottomrail, that is to be cut down by the cutting device. Examples of such cutting machines are disclosed in U.S. Pat. Nos. 5,816,126, 6,412,381 and 6,945,152. Such window covering cutting machines typically have cutting devices that follow substantially vertical or substantially horizontal cutting paths to cut down window covering work pieces. A work piece is positioned perpendicular to the cutting path so that the work piece is trimmed down to have straight sides or ends. A circular saw or similar rotary blade mechanism is provided in some blind cut-down machines. Others use die sets and/or guillotine blade arrangements.

Valances are often sold by the same retailers that sell window covering products such as venetian blinds, cellular shades or roman shades. Valances are generally decorative bodies that are mounted adjacent a window opening to frame the top or side portions of the window opening. The valances may also cover portions of a window covering, such as the headrail portion of a shade or blind. Many types of valances have generally U-shaped bodies that include multiple interconnected valance portions. Valances are normally custom made for a particular window opening.

To purchase a valance, a homeowner or other customer typically measures the dimensions of a window opening and then orders a valance based on the measured dimensions of the window opening to ensure the valance properly frames the opening. Often, a customer will report the measured dimensions to a retailer who then orders a custom made valance from a valance fabricator based on the measured dimensions. Valances may be made from various processes, such as the process disclosed in U.S. Pat. No. 6,629,481. Generally, a consumer must wait many days, if not weeks, for a fabricator to create and ship a custom made valance he or she has ordered.

Typically, manufacturers make a valance from elongated pieces of wood or plastic that have one or more sides shaped to provide a desired aesthetic effect. For instance, some valances are configured to have exterior facing sides that have grooves or embossments. Valances are often made from three elongated members that are connected to form a U-shaped body by brackets, fasteners or adhesives. As disclosed by U.S. Pat. No. 6,629,481, a fabricator may find it desirable to cut one elongated stock member into three pieces, a central member and two side members. The valance is then formed by connecting each side member to a respective end of the central member. Each member of the valance often has at least one end cut at an angle, such as a 45 degree angle. The angled ends of the central member are connected to an angled end of a respective side member to form the valance. Such angled ends are often desirable because of the aesthetic effect the connected angled ends provide.

The cutting of each valance member is usually performed by the fabricator. The fabricator often uses a fabrication process that employs a cutting station that has a cutting blade configured to cut the valance members. The cutting blades are normally configured to cut each member of the valance along an angled cutting path to form the angled ends for each member of the valance. The angled cutting path may be defined by a miter box that defines the angled cutting path a blade may travel along or by a cutting device configured to move along a cutting path that is at an acute angle relative to the valance component. Such cutting paths are substantially different than the cutting paths of blades, dies or other cutting devices provided in typical window covering cutting machines or blind cutting machines. Such window covering cutting machines typically have substantially horizontal or substantially vertical cutting paths that do not cut a work piece to provide an acutely angled or tapered end or side.

I have recognized that many consumers desire to purchase valances for use with blinds that have been cut down to fit a particular window opening. However, retailers who offer cut-down blinds do not offer a cut down program for valances. Consequently, there is a need for equipment that will enable retailers to immediately provide cut-down stock sized valances to a consumer, which permits the consumer to avoid the delays in receiving a custom made valance from a valance fabricator. Such equipment should be inexpensive and not require much space in the retail store. Preferably the equipment used to trim valances should work in cooperation with the equipment used to cut down blinds. Moreover, the mechanism used for cutting down stock valances should also be suitable for cutting other work pieces to provide the cut down components with angled ends or tapered sides.

### SUMMARY OF THE INVENTION

I provide a cutting machine for trimming window covering work pieces such as window coverings and window covering components. My cutting machine includes a stand, a cutting mechanism and a work piece positioning mechanism. The cutting mechanism is adjacent the stand and has at least one blade configured to move along a cutting path to cut a work piece. The work piece positing mechanism is sized and configured to hold a work piece. The work piece positioning mechanism is adjacent the cutting mechanism and is moveable from a first position to a second position. The work piece positioning mechanism is sized and configured to hold a work piece at an acute angle relative to the cutting path when the work piece positioning mechanism is in the second position.

Preferably, the work piece positioning mechanism is sized and configured to hold a work piece at any angle between 30° and 60° relative to the cutting path when the work piece positioning mechanism is in the second position. Most preferably, the work piece positioning mechanism is sized and configured to hold a work piece at a 45 degree angle relative to the cutting path when the work piece positioning mechanism is in the second position.

In some embodiments, the one or more blades may be rotary cutting blades. The cutting path along which the one or more blades move may be substantially horizontal or substantially vertical.

The cutting mechanism may include a housing. The work piece positioning mechanism can be configured to move relative to the housing from a first position to a second position that is located further inside the housing than the first position.

The work piece positioning mechanism can include a clamp that has a clamping body that is moveable from on open position to at least one clamping position. When in the open position, the clamping body may receive a work piece. When in one or more of the clamping positions, the clamping body may engage or hold the work piece. In some embodiments, the clamp may also include a hand screw connected to the clamping body that is configured to lock the clamping body in one or more clamping positions.

The work piece positioning mechanism may be removably connected to the cutting mechanism or stand. When the work piece positioning mechanism is removably connected to the stand or cutting mechanism, the work piece positioning mechanism may be moved away from the cutting mechanism. For example, the work piece positioning mechanism may be moved away from the work piece positioning mechanism and stored in a storage container until it is needed to help cut a window covering work piece.

The work piece positioning mechanism may be configured to move along a slot formed in the stand or the cutting mechanism. In some embodiments, the slot may extend from the stand to the cutting mechanism. For example, the slot may be formed in a work surface of the stand and extend through at least a portion of the bottom of the cutting mechanism housing. The work piece positioning mechanism may move along the slot from the first position to the second position. In one embodiment, the first position may be located at a first end of the slot and the second position may be located at an opposite second end of the slot.

In other embodiments the work piece positioning mechanism includes a first moveable body and a clamping body. The first moveable body is rotatable from the first position to the second position. The clamping body is moveable relative to the first moveable body such that the clamping body is moveable from an open position to one or more clamping positions. The work piece positioning mechanism can also include an operator mechanism sized and configured to move the clamping body from the open position to the one or more clamping positions.

In some embodiments, the work piece positioning mechanism is sized and configured to hold at least a portion of a valance. In other embodiments, the work piece positioning mechanism may be configured to hold at least a portion of various window covering work pieces, such as headrails, valances, blinds, shades, valances, bottom rails, or vertical slats and other window covering material.

The stand may include a work surface attached to the base. In some embodiments, a sidewall is attached to the work surface and one or more access gates are provided in the sidewall such that the one or more access gates are moveable from a closed position to an open position.

At least one locking device may be provided adjacent the stand or the cutting mechanism. The one or more locking devices are sized and configured to releasably hold the work piece positioning mechanism in at least one of a first position and a second position. The one or more locking devices may include one or more magnetic elements. In some embodiments, one or more of the magnetic elements are configured to connect or releasably connect to the one or more magnetic elements of a locking device or locking devices.

A first locking device and a second locking device can be included in my cutting machine. The first locking device is configured to releasably hold the work piece positioning mechanism in the first position and the second locking device is configured to releasably hold the work piece positioning mechanism in the second position. Preferably, the magnetic elements are configured to have a magnetic field that is strong enough to connect to other magnetic elements without having to directly contact the physical body or structure of other magnetic elements such that one or more of the magnetic elements may be within a structure, but still releasably hold the work piece positioning mechanism.

A method of selling window coverings is also provided. My method includes providing a window covering cutting machine, providing at least one valance component to be cut down by the window covering cutting machine, providing at least one blind component to be cut down by the window covering cutting machine and cutting the one or more blind components and one or more valance components with the window covering cutting machine. The window covering cutting machine includes a stand and a cutting mechanism adjacent the stand. The cutting mechanism has at least one blade configured to move along a cutting path to cut a work piece. The at least one blind component can include a headrail, a bottom rail, window covering material, a venetian blind and a shade. The at least one valance component can include valances or valance components such as a valance or portions of a valance.

In some embodiments of my method the window covering cutting machine also includes a work piece positioning mechanism sized and configured to hold a work piece. The work piece positioning mechanism is positioned adjacent the cutting mechanism and is moveable from a first position to a second position. The work piece positioning mechanism is sized and configured to hold a work piece, such as a valance component or a blind component, at an acute angle relative to the cutting path when the work piece positioning mechanism is in the second position.

Other objects and advantages of the present invention will become apparent from a description of certain present preferred embodiments thereof shown in the drawings.

### BRIEF DESCRIPTION OF THE DRAWINGS

FIG. 1 is a perspective view of a first present preferred embodiment of my cutting machine with the cutting mechanism housing in an open position to reveal a rotary blade within the housing and the access gate in a closed position.

FIG. 2 is a perspective view of the first present preferred embodiment of a portion of my cutting machine showing the cutting mechanism housing in a closed position, the access gate in an open position and a work piece held within a first present preferred embodiment of my work piece positioning mechanism.

FIG. 3 is a top plan view of a portion of the first present preferred embodiment that illustrates the work piece positioning mechanism in the first position and also illustrates the second position of the work piece positioning mechanism in dotted line.

FIG. 4 is a side view of a second present preferred embodiment of the work piece positioning mechanism with a portion of the work piece positioning mechanism cut away to illustrate a guide member of the second embodiment of the work piece positioning mechanism.

FIG. 5 is a fragmentary view of the first present preferred embodiment of my cutting machine showing the first present preferred embodiment of my work piece positioning mechanism located in the second position and holding a portion of a work piece.

FIG. 6 is a perspective view of the first present preferred embodiment of the work piece positioning mechanism.

FIG. 7 is a perspective view of a third present preferred embodiment of the work piece positioning mechanism.

FIG. 8 is a top plan view of a portion of a second present preferred cutting machine showing the work piece positioning mechanism in the active position and the clamping body in an open position.

FIG. 9 is a perspective view of a valance that can be formed from valance members, or valance portions, cut down by an embodiment of my cutting machine.

### DESCRIPTION OF THE PRESENT PREFERRED EMBODIMENTS

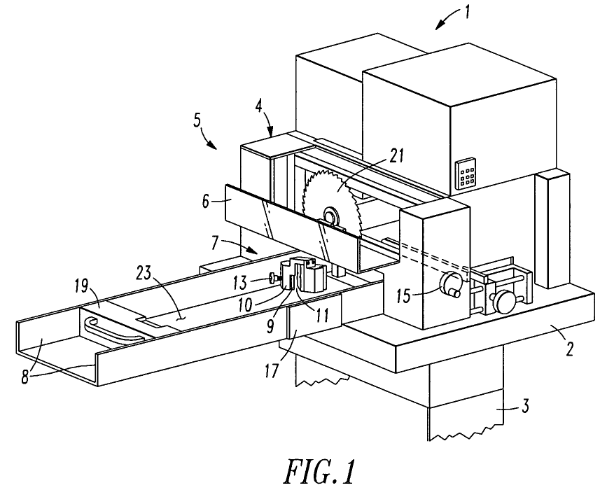

A first present preferred embodiment 1 of my cutting machine is illustrated in FIG. 1. The cutting machine 1 has a stand 3 that includes a base 2. A cutting mechanism 5 is attached to the base 2. A work surface 23 extends from the base 2 and a locator 19 is moveably attached to the work surface 23. The locator 19 is positioned to hold different work pieces, such as blinds, shades, headrails or bottom rails that may be cut by the cutting mechanism 5 and to move those work pieces along the work surface 23.

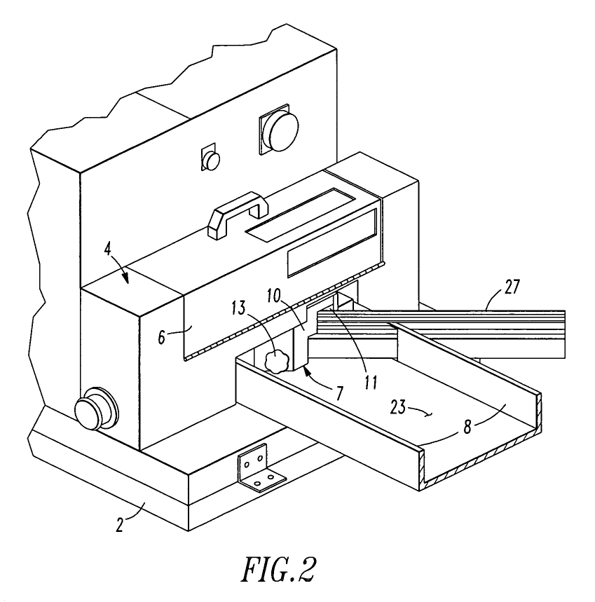

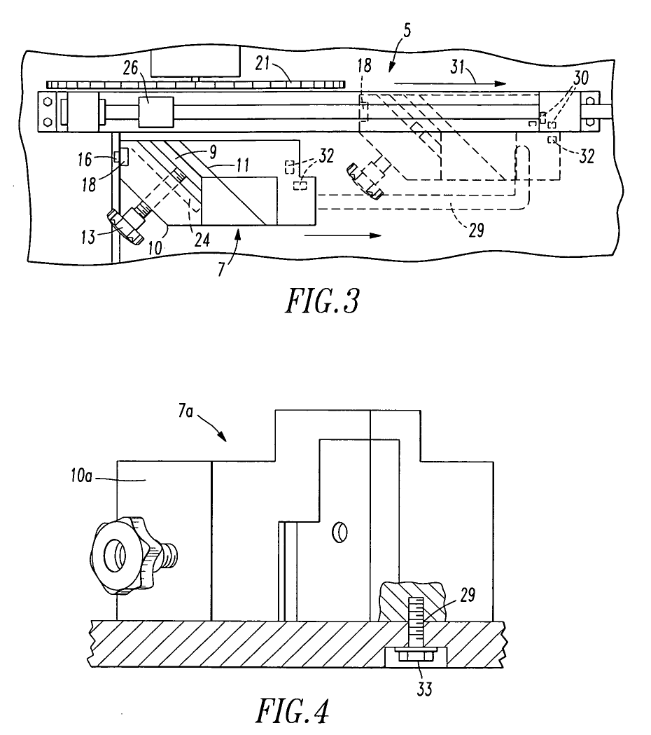

Sidewalls 8 are attached to the work surface 23. An access gate 17 is provided in the sidewall 8. The access gate 17 is moveable from a closed position, which is shown in FIG. 1, to an open position, which is shown in FIG. 2. The access gate 17 may be moveably connected to the sidewall 8 such that the access gate can be moved from a closed position to an open position or removably connected to the sidewall 8. The cutting mechanism 5 includes a rotary cutting blade 21 that is within the housing 4 of the cutting mechanism 5. The cutting mechanism housing 4 has a door 6 that can be positioned in an open position, which is shown in FIG. 1, or closed position, which is shown in FIG. 2. A work piece positioning mechanism 7 is located adjacent the cutting mechanism 5 on the work surface 23. An operator mechanism 15 is operatively connected to the work piece positioning mechanism 7 so an operator may manipulate the operator mechanism 15 to adjust the position of the work piece positioning mechanism 7. Preferably, the work piece positioning mechanism 7 is movable between a rest or stowed position shown in FIG. 1 and an active position shown in FIG. 2. In FIG. 3 the work pieces positioning mechanism is shown in solid line at the rest position and shown in dotted line in the active position.

The work piece positioning mechanism 7 has a body 10 that defines a slot 11. A clamping body 9 is attached to the body 10 and is located within the slot 11. A hand screw 13 is attached to the clamping body 9 and passes through body 10. The hand screw 13 is used to adjust the position of the clamping body 9, which may increase or decrease the width of the slot 11 to receive or hold a work piece. A work piece may be inserted into the slot 11 when the clamping body is positioned in an open position. After a work piece is inserted into the slot, the clamping body can be adjusted to a clamping position to hold the work piece. The location of the clamping position relative to the body 10 may be a different position for different work pieces because of differences in width of the work pieces. Of course, the body 10 and clamping body 9 of the work piece positioning mechanism can be sized and configured to receive and hold multiple work pieces so the work pieces can be cut at the same time with one cutting pass of rotary cutting blade 21. For example, the two sides of a valance may be cut together.

As shown in FIG. 3, the body 10 of the work piece positioning mechanism 7 may include a cavity 24 adjacent the slot 11. The cavity 24 is sized to receive at least a portion of the clamping body 9. Preferably, the entire clamping body 9 may be retained within the cavity 24. The clamping body 9 is configured to retract partially or completely within the cavity 24 to receive a work piece. Once a work piece has been inserted into the slot 11, the clamping body may extend partially or completely out of the cavity and into the slot 11 to engage at least a portion of the work piece inserted within the slot. It should be appreciated that the recess 24 permits the work piece positioning mechanism 7 to hold work pieces within the slot 11 that are as wide as the slot 11.

Referring to FIG. 2, a work piece 27 about to be cut down by the cutting machine 1 is inserted through an opening in a sidewall 8 after the access gate 17 has been placed in an open position. The work piece 27 is within slot 11 of the work piece positioning mechanism 7. When the work piece positioning mechanism is in the stowed position as shown in FIG. 1, it is located such that it does not interfere with the cutting down of work pieces such as blinds, headrails or bottom rails. The stowed position may be located on the work surface 23 adjacent the cutting mechanism housing 4 or in other positions adjacent the work surface 23 or cutting mechanism 5.

The work piece positioning mechanism 7 is freely moveable from the stowed position to the active position shown in dotted line in FIG. 3. The work piece positioning mechanism 7 may also be moved away from the work surface 23 or cutting mechanism housing 4. Preferably, the work piece positioning mechanism is configured so it can be manually slid along the substantially smooth work surface 23, the bottom of the cutting mechanism housing, or both. When the work piece positioning mechanism 7 is moved to the active position, as shown in dotted line in FIG. 3, a work piece 27 held by the work piece positioning mechanism 7 is at an acute angle θ relative to the cutting path 31 of the rotary cutting blade 21. When the work piece positioning mechanism 7 is in the active position, the work piece 27 is preferably held at an acute angle between 30 and 60 degrees relative to the cutting path 31. Most preferably, the acute angle is 45 degrees.

The work piece positioning mechanism 7 may be configured to move adjacent the cutting mechanism 5 or work surface 23 in various other ways. For example, the work piece positioning mechanism may be configured to move from the stowed position to the active position by an actuator or by manual movement along a path defined by one or more rails or rods (not shown) positioned on, in or below the work surface 23.

The path may be defined by a slot or passageway through the work surface 23. When a slot is provided, I provide a second embodiment of the work piece positioning mechanism 7a that may have at least one guide member 33, as shown in FIG. 4. The guide member is configured to extend from the body 10a of the work piece positioning mechanism 7a through a slot 29 to removably connect the work piece positioning mechanism adjacent the cutting mechanism housing 4 or work surface 23. The slot 29, which is shown in dotted line in FIG. 3, may be formed in the work surface 23, the cutting mechanism housing 4, or formed in both. In this embodiment the guide member connects or attaches the work piece positioning mechanism to the blind cutting machine. The guide member may be connected to an operator mechanism 15 such that manipulation of the operator mechanism 15 adjusts the position of the work piece positioning mechanism 7a. Of course, the guide member 33 may also be configured so a user can manually adjust the position of the work piece positioning mechanism 7 by sliding the work piece positioning mechanism 7 along the path defined by slot 29.

It should be appreciated that guide member 33 can be configured to releasably connect to the work piece positioning mechanism 7a. Then the work piece positioning mechanism can be removably connected to the stand, work surface or cutting machine housing. When the work piece positioning mechanism is not needed, the guide member may be removed from the work piece positioning mechanism. After removal the work piece positioning mechanism 7a may be stored in a storage cabinet, on a shelf below or adjacent the stand 3 or at any other location.

A moveable locking member 26 may be connected to the cutting mechanism housing 4, work surface 23 or base 2 to lock the position of the work piece positioning mechanism 7. In some embodiments, a separate actuator may move the locking member 26. In other embodiments, the locking member will be configured to automatically move to lock the position of the work piece positioning mechanism when it is in the active position. Thereafter, a user can cause the locking member 26 to move to an unlocked position to adjust the position of the work piece positioning mechanism 7. In other embodiments, a controller (not shown) may be configured to automatically adjust the position of the locking member 26 before and after a work piece has been trimmed.

One or more magnetic elements 16 may be connected to a sidewall 8 or cutting mechanism housing 4 to releasably hold the work piece positioning mechanism in the stowed position such that the work piece positioning mechanism 7 does not interfere with the cutting down of various work pieces when it is in the stowed position. A magnetic element 16 may be configured to attract any portion of body 10 of the work piece positioning mechanism 7 or may be configured to attract a magnetic body 18 that is attached to the work piece positioning mechanism 7.

The magnetic attraction between the magnets can be configured so that the force provided by a user to move the work piece positioning mechanism may overcome the attraction between the magnetic element 16 and the body 10 or magnetic body 18. In other embodiments, the magnetic element 16 may be configured to have an adjustable magnetic field such that a user or controller may cause the magnetic field emitted by the magnetic element 16 to change so the magnetic element may hold or release the body 10 of the work piece positioning mechanism so a user or actuator may move the work piece positioning mechanism to the active position.

One or more magnetic elements 30 can also be attached adjacent a sidewall 8 or adjacent the cutting mechanism housing to lock or releasably hold the work piece positioning mechanism in the active position. The magnetic elements 30 may hold the work piece positioning mechanism by releasably connecting with one or more magnetic elements 32 attached to or within the body 10 of the work piece positioning mechanism 7.

As shown in FIG. 7, a third present preferred work piece positioning mechanism 37 can include a body 38 that defines a slot 44. A clamping body 39 is positioned within the slot 44. A U-shaped body 43 is attached to the clamping body 39. A hand screw 41 is attached to the U-shaped body 43. The U-shaped body may be moved or slid along the body 38 of the work piece positioning mechanism 37 to adjust the position of the clamping body 39 within the slot 44. The hand screw can also lock the position of the clamping body by being manipulated to engage the body 38 of the work piece positioning mechanism 37. The work piece positioning mechanism 37 may be adjusted relative to the cutting mechanism or cutting path 31 of the rotary cutting blade 21 similarly to the work piece positioning mechanism 7 of the first present preferred cutting machine 1 discussed above.

The work piece positioning mechanism 7 may be retrofitted on existing window covering cutting machines or provided in new window covering cutting machines. For embodiments of my invention that include a retrofitted work piece positioning mechanism 7, the work piece positioning mechanism may be sold separate from the window covering cutting machine. Installation work may also be provided to ensure that a separately sold work piece positioning mechanism may move from the stowed position to the active position.

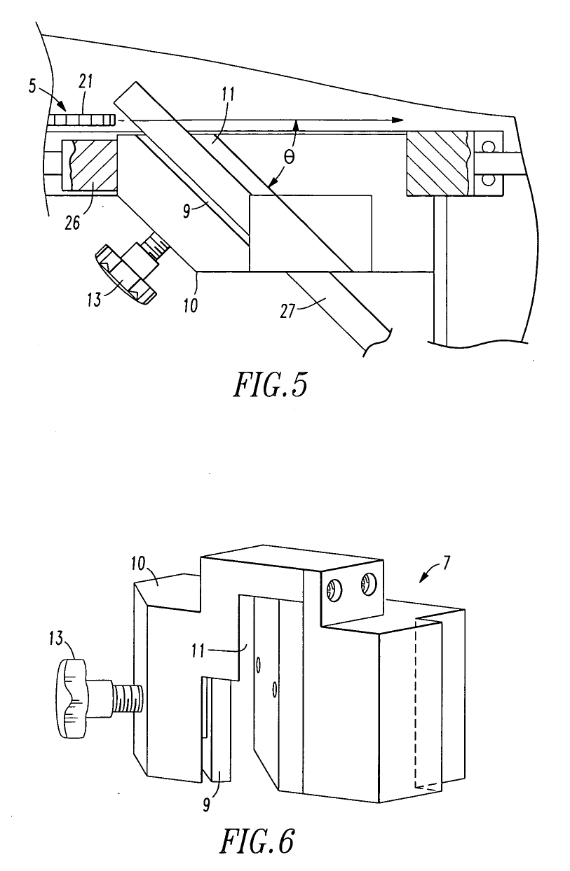

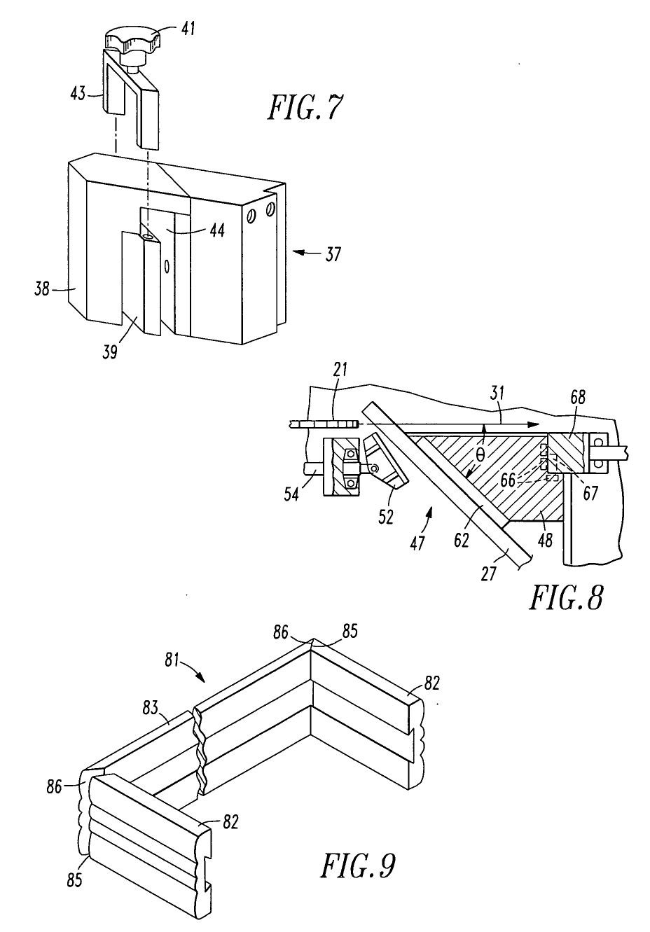

The work piece positioning mechanism may be configured to move differently from the embodiments shown in FIGS. 1 through 7. For instance, a third present preferred embodiment of the work piece positioning mechanism 47, which is illustrated in FIG. 8, can include a moveable body 48 that is moveable from a stowed position to an active position and a clamping body 52 that is moveable relative to the moveable body 48. The clamping body 52 may be moved relatively far from the moveable body 48 to an open position so a work piece may be inserted between bodies 48 and 52, and then moved to a clamping position to engage a work piece so the bodies 48 and 52 hold the work piece. A cushion 62 may be attached to the body 48 to reduce the likelihood that a work piece engaged by the clamping body 52 may become damaged. A clamping mechanism that includes a threaded shaft 54 may be connected to the clamping body 52 to permit a user, actuator or controller to adjust the position of the clamping body 52. Preferably, the clamping body 52 is rotatably attached to the shaft member 54 so the clamping body 52 may pivot to engage a work piece that is positioned against the moveable body 48.

A locking device 68 may be connected to the cutting mechanism housing or a sidewall to lock the position of the body 48 adjacent the cutting path 31 of the rotary cutting blade 21 so that a work piece against the body 48 or cushion 62 is at an angle θ relative to the cutting path 31. The locking device may be configured to engage a portion of the body 48 or releasably interlock with a portion of the body 48. Preferably, the locking device 68 includes one or more magnetic elements 67 that are configured to attract and hold one or more magnetic elements 66 attached within or onto body 48. Of course, body 48 may be composed of a magnetic material such that the magnetic element 67 can directly attract to and hold the body 48 in the active position.

When the work piece positioning mechanism holds a work piece 27 and is moved to the active position, the work piece is at an acute angle relative the cutting path 31 of the rotary cutting blade 21. The blade may then pass along a substantially horizontal or substantially vertical cutting path to cut the work piece such that the work piece has an angled end 85. The different work pieces 27 may be cut to form portions of a valance 81, such as a central member 83 and two side members 82 as shown in FIG. 9. After cutting, both ends 86 of the central member 83 and an end 85 of each side member 82 are angled. The valance 81 may then be formed by connecting an angled end 85 of each side member 82 with a respective angled end 86 of the central member 83. The angled ends may all be at 45 degree angles so the central member and side members form respective right angles. Alternatively, the angled ends 86 of the central member may be cut at one angle, such as a 30 degree angle, and the ends 85 of the side members 82 may be cut at a complementary angle, such as a 60 degree angle, so that the ends 85 of the side members and ends 86 of the central member form respective right angles. Of course, the ends may also be cut so the abutting ends do not form right angles.

After the valance components have been cut down, the work piece positioning mechanism can be moved to its stowed position and window covering components, such as blinds, headrails, or bottom rails, may be cut down by the cutting machine. It should be understood that the order in which the work pieces are cut may be different depending on what work pieces are needed to meet the needs of a customer or to allow a user to efficiently use his or her time and reduce the frequency with which the work piece positioning mechanism is moved from the stowed position to the active position. For instance, a sales associate or other operator may alternatively choose to cut down multiple valance components for different customers after a blind or the other window covering component has been cut down for one customer.

While I have illustrated embodiments of my cutting machine holding a portion of a valance about to be trimmed, it should be understood that embodiments of my cutting machine may be configured to cut numerous different window covering work pieces. The present invention is not limited to only cutting valance members or only cutting one type of window covering work piece. For instance, the work piece positioning mechanism may be used to cut slats, head rails or bottom rails. It is currently contemplated, however, that the work piece positioning mechanism is most advantageously used for cutting portions of a valance.

It should be appreciated that embodiments of my cutting machine can permit a retailer to cut down blind components and valance components with the same machine. This permits the retailer to offer or provide, both stock blinds and stock valances. The stock blinds or stock blind components such as headrails, bottom rails, window covering material, blinds and shades, and stock valances or valance components such as valances, valance side members and valance central members, can be displayed to customers, sold and delivered at the same time. Such retail services avoid the delays that often result in ordering custom made valances.

Although I have described and illustrated certain present preferred embodiments of my cutting machine and methods of trimming window covering work pieces, the invention is not limited thereto and may be variously embodied within the scope of the following claims.

I claim:

1. A cutting machine for trimming window coverings and window covering components comprising:
a stand;
a cutting mechanism adjacent the stand, the cutting mechanism having at least one blade configured to move along a cutting path to cut a work piece; and
a work piece positioning mechanism sized and configured to hold a work piece, the work piece positioning mechanism adjacent the cutting mechanism, the work piece positioning mechanism moveable from a first position to a second position, the work piece positioning mechanism sized and configured to hold a work piece at an acute angle relative to the cutting path when the work piece positioning mechanism is in the second position.

2. The cutting machine of claim 1 wherein the work piece positioning mechanism is comprised of a clamp having a clamping body that is moveable from an open position to at least one clamping position and the clamp further comprises a screw connected to the clamping body that is configured to lock the clamping body in the at least one clamping position.

3. The cutting machine of claim 1 wherein the work piece positioning mechanism is removably connected to at least one of the cutting mechanism and the stand such that the work piece positioning mechanism can be moved away from the cutting mechanism.

4. The cutting machine of claim 1 wherein the work piece positioning mechanism is configured to move along a slot formed in at least one of the stand and the cutting mechanism.

5. The cutting machine of claim 1 wherein the work piece positioning mechanism is sized and configured to hold a work piece at an angle of from 30° to 60° relative to the cutting path when the work piece positioning mechanism is in the second position.

6. The cutting machine of claim 1 wherein the work piece positioning mechanism is comprised of a first moveable body and a clamping body, the first moveable body rotatable from a first position to a second position, the clamping body moveable relative to the first moveable body such that the clamping body is moveable from an open position to at least one clamping position.

7. The cutting machine of claim 6 wherein the work piece positioning mechanism is further comprised of an operator mechanism sized and configured to move the clamping body from the open position to the at least one clamping position.

8. The cutting machine of claim 7 wherein the operator mechanism has a member and the clamping body is rotatably connected to the member.

9. The cutting machine of claim 6 wherein the first moveable body has a slot, the slot defining a path of rotation along which the first moveable body can rotate

10. The cutting machine of claim 1 further comprising a sidewall attached to the work surface and at least one access gate connected to the sidewall such that the access gate is moveable from an open position to a closed position.

11. The cutting machine of claim 1 also comprising at least one locking device sized and configured to releasably hold the work piece positioning mechanism in at least one of the first position and the second position, the at least one locking device comprising at least one magnetic element; the at least one locking device adjacent at least one of the stand and the cutting mechanism.

12. The cutting machine of claim 11 further comprising at least one magnetic element attached to the work piece positioning mechanism that is configured to connect to the at least one magnetic element of the at least one locking device.

13. The cutting machine of claim 11 wherein the cutting mechanism is further comprised of a cutting mechanism housing and the at least one locking device being comprised of a first locking device attached adjacent to the cutting mechanism housing and a second locking device attached adjacent to the cutting mechanism housing, the first locking device configured to releasably hold the work piece positioning mechanism in the first position and the second locking device configured to releasably hold the work piece positioning mechanism in the second position.

14. A work piece positioning mechanism for use in combination with a blind cutting machine of the type having a blade which moves along a cutting path comprising:
a housing having a size and shape such that the housing may be placed on a blind cutting machine adjacent a cutting path in the blind cutting machine, the housing defining a slot sized to receive a work piece that can be trimmed to create a component of a valance, the slot being at an acute angle to the cutting path when the housing is positioned adjacent the cutting path;
a clamping body connected to the housing in a manner so that the clamping body may move within the slot in the housing, and
an attachment member on the housing for attaching the housing to a blind cutting machine.

15. The work piece positioning member of claim 14 also comprising a hand screw attached to the clamping body.

16. The work piece positioning member of claim 14 wherein the housing has a cavity adjacent the slot, the cavity being sized and configured to receive the clamping body.

17. The work piece positioning mechanism of claim 14 wherein the attachment member comprises magnets.

18. A method of selling window covering components comprising:
providing a window covering cutting machine having at least one blade configured to move along a cutting path to cut a work piece;
providing at least one valance component to be cut down by the window covering cutting machine;
providing at least one window covering component to be cut down by the window covering cutting machine; and
cutting both the at least one window covering component and the at least one valance component with the window covering cutting machine.

19. The method of claim 18 wherein the at least one window covering component is at least one of a headrail, a bottom rail, window covering material, and a venetian blind.

20. The method of claim 18 wherein the window covering cutting machine is further comprised of a work piece positioning mechanism sized and configured to hold a work piece, the work piece positioning mechanism being adjacent the cutting mechanism, the work piece positioning mechanism moveable from a first position to a second position, the work piece positioning mechanism sized and configured to hold a work piece at an acute angle relative to the cutting path when the work piece positioning mechanism is in the second position.
